(19) United States
(12) Patent Application Publication
(10) Pub. No.: US 2026/0149963 A1
(43) Pub. Date: May 28, 2026

(54) METHODS AND SYSTEMS FOR REENABLING N1 MODE FOR 3GPP ACCESS IN A USER EQUIPMENT

(71) Applicant: Samsung Electronics Co., Ltd., Suwon-si (KR)

(72) Inventors: Utsav SINHA, Bangalore (IN); Lalith KUMAR, Bangalore (IN); Danish Ehsan HASHMI, Bangalore (IN); Anurag MANDILWAR, Bangalore (IN); Vishal YADAV, Bangalore (IN)

(21) Appl. No.: 19/448,835

(22) Filed: Jan. 14, 2026

Related U.S. Application Data
(63) Continuation of application No. PCT/KR2024/014762, filed on Sep. 27, 2024.

(30) Foreign Application Priority Data
Sep. 29, 2023 (IN) 202341065735
Sep. 6, 2024 (IN) 2023 41065735

(51) Int. Cl. H04W 8/22; H04W 12/06; H04W 48/18

(52) U.S. Cl. CPC H04W 8/22; H04W 12/068; H04W 48/18

(57) ABSTRACT

A method and system for re-enabling a N1 mode capability for 3rd generation partnership project (3GPP) access in a user equipment (UE) are provided. The method includes determining that the UE supports an access to a standalone non-public network (SNPN), identifying that N1 mode capability is disabled in the UE, determining first validity information associated with the SNPN, and re-enabling the N1 mode capability upon determining that the first validity information associated with the SNPN changes from not met to met.

### CROSS-REFERENCE TO RELATED APPLICATION(S)

This application is a continuation application, claiming priority under 35 U.S.C. § 365(c), of an International application No. PCT/KR 2024/014762, filed on Sep. 27, 2024, which is based on and claims the benefit of an Indian Provisional patent application number 202341065735, filed on Sep. 29, 2023, in the Indian Complete Patent Office, and of an Indian patent application number 202341065735, filed on Sep. 6, 2024, in the Indian Patent Office, the disclosure of each of which is incorporated by reference herein in its entirety.

### BACKGROUND

### 1. Field

The disclosure relates to the field of wireless communication networks. More particularly, the disclosure relates to methods and systems for re-enabling a N1 mode for 3rd generation partnership project (3GPP) access in a user equipment (UE).

### 2. Description of Related Art

3rd generation partnership project (3GPP) has introduced the concept of localized services. Localized service is a service that is localized (i.e. provided at a specific/limited area) and/or may be bounded in time. The service may be realized via applications (e.g. live or on-demand audio/video stream, electric game, internet protocol (IP) multimedia subsystem (IMS), etc.), or connectivity (e.g. user equipment (UE) to UE, UE to data network, etc.). A service provider that provides such service is called a Localized service provider. A Localized service provider is an application provider or network operator who makes their services localized and offered to end users via a hosting network. Such localized service providers are also known as non-public networks (NPNs). NPNs are designed for non-public use and intended for exclusive deployment by enterprises and other private entities. These networks may be configured in various ways, including as standalone networks, hosted by public land mobile networks (PLMNs), or offered as a network slice of a PLMN. The NPNs may be deployed as standalone non-public networks (SNPNs), which operate independently of PLMN network functions, or as public network integrated NPNs, supported by the PLMN. UE that supports SNPNs may also work in an N1 mode. In N1 mode, the UE has access to a fifth generation (5G) core network (5GC) via the 5G access network. This mode is indicative of a successful 5GC attach, which means the UE is connected to the 5G network and may utilize its services.

UEs that SNPNs are equipped with a “list of subscriber data” containing subscriber identifiers (subscription permanent identifiers, or SUPIs), authentication credentials, SNPN identities, and optionally, access identities and pre-configured rules. The foregoing information allows users to register without a strong dependency on universal subscriber identity modules (USIMs).

According to 3GPP, if the UE supports access to the SNPN providing access for localized services in SNPN, the SNPN selection parameters for access for localized services in SNPN may include:
i) a “credentials holder controlled prioritized list of preferred SNPNs for access for localized services in SNPN”, where each entry contains an SNPN identity and a validity information consisting of time validity information; and
ii) a “credentials holder controlled prioritized list of preferred group network identifications (GINs) for access for localized services in SNPN”, where each entry contains a GIN and a validity information consisting of time validity information.

The validity information consists of:
Time validity information, i.e. time periods (defined by start and end times) when access to the SNPN for accessing Localized Services is allowed; and
optionally location validity information consisting of tracking area(s) of SNPN(s); and
optionally location assistance information consisting of Geolocation information, and/or Tracking Area information of serving networks, i.e. lists of tracking area codes (TACs) per PLMN ID or per PLMN ID and network identification (NID).

As per 3GPP, if the UE supports access to an SNPN using credentials from the credentials holder, equivalent SNPNs and/or the UE should maintain one or more lists of SNPNs where the N1 mode capability was disabled. The N1 mode could have been disabled because the IMS voice was not available, and the UE's usage setting was “voice centric” associated with an entry of the “list of subscriber data”.

Further, if the UE supports access to the SNPN using credentials from the credential's holder, the UE should maintain a list of SNPNs where the N1 mode capability was disabled because IMS voice was not available and the UE's usage setting was “voice centric”, associated with the PLMN subscription.

Furthermore, if the UE supports access to the SNPN using credentials from the credential's holder, equivalent SNPNs and/or the UE shall use the lists associated with the selected entry of the “list of subscriber data” or the selected PLMN subscription.

According to 3GPP, the UE may disable N1 mode for a particular SNPN for an event-X trigger. Some non-limiting examples of the event-X trigger may be as follows:
a. IMS voice is not available when UE is voice centric.
b. Maximum registration failure leading to registration attempt becoming of maximum value.
c. Registration rejected with 5G mobility management (5GMM) cause #27 (N1 mode not allowed). This is not limited to the registration procedure but may be for other non-access stratum (NAS) messages as well.
d. Registration rejected with 5GMM cause #62 (No network slices available). This is not limited to the registration procedure but may be for other NAS messages as well.

FIG. 1 illustrates a signal flow diagram 100 depicting an inability of the UE to access SNPN for localized services due to N1 mode disablement, according to the related art.

Referring to FIG. 1, at operation 102, the UE 101 supports access to the SNPN providing access to localized services in the SNPN. At operation 104, access for localized services in SNPN is enabled. At operation 106, the UE is configured with the below, for the selected entry of the “list of subscriber data” or PLMN subscription:
i. “credentials holder controlled prioritized list of the preferred SNPNs for access for localized services in SNPN” with entries for example:
a. SNPN-1, time validity from 2 pm to 3 pm of the day.
b. SNPN-2 from 4 pm to 5 pm of the day.
ii. “credentials holder controlled prioritized list of preferred GINs for access for localized services in SNPN” with entries:
a. GIN-1, time validity from 2 pm to 3 pm of the day.
b. GIN-2, time validity from 4 pm to 5 pm of the day.

At operation 108, the UE tries to access SNPN-1. For example, the UE tries to register with SNPN-1 by transmitting a registration request to a network entity, such as access and mobility management function (AMF) 103. At operation 110, the Event-X is triggered. For example, the UE receives a non-access stratum (NAS) message from the AMF 103 i.e., registration rejection with cause #27 (N1 mode not allowed). At operation 112, the event-X triggers the N1 mode to get disabled for SNPN-1, for instance at 1 pm of the day. At operation 114, in one example, at 2 pm of the day, N1 mode stays disabled for SNPN-1, and the UE 101 cannot access SNPN-1 for localized services in the SNPN-1.

FIG. 2 illustrates a signal flow diagram 200 depicting an inability of the UE to access SNPN for localized services due to N1 mode disablement, according to the related art.

Referring to FIG. 2, at operation 202, the UE 201 supports access to the SNPN providing access to localized services in the SNPN. At operation 204, access for localized services in the SNPN is enabled. At operation 206, the UE 2011 is configured with the below, for the selected entry of the “list of subscriber data” or PLMN subscription:
i. “credentials holder controlled prioritized list of preferred SNPNs for access for localized services in SNPN” with entries, for example:
a. SNPN-1, time validity from 2 pm to 3 pm of the day.
b. SNPN-2 from 4 pm to 5 pm of the day.
ii. “credentials holder controlled prioritized list of preferred GINs for access for localized services in SNPN” with entries:
a. GIN-1, time validity from 2 pm to 3 pm of the day.
b. GIN-2, time validity from 4 pm to 5 pm of the day.

At operation 208, the UE 201 tries to access SNPN-1. In an example, the UE 201 tries to register with SNPN-1 using GIN-1, i.e., GIN associated with SNPN-1. The UE 201 may receive GIN-1 from a network associated with the AMF 203. Accordingly, the UE 201 may try to register with the SNPN-1 by transmitting GIN-1 to the AMF 203. At operation 210, the Event-X is triggered. For example, the UE 201 receives the NAS message, i.e., example registration accept, with IMS voice not available, and the UE's usage setting is “Voice centric”. At operation 212, the event-X triggers the NI mode to get disabled for SNPN-1, for example at 1 pm of the day. At operation 214, at 2 pm of the day, N1 mode stays disabled for SNPN-1, and UE 201 cannot access SNPN-1 for localized services in the SNPN-1.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for re-enabling a N1 mode capability for 3rd generation partnership project (3GPP) access in a user equipment (UE).

Additional aspects will be set forth in part in the description which follows and, in part, will be apparent from the description, or may be learned by practice of the presented embodiments.

In accordance with an aspect of the disclosure, a method for re-enabling a N1 mode capability for 3GPP access in a user equipment (UE) is provided. The method includes determining that the UE supports access to a standalone non-public network (SNPN), identifying that N1 mode capability is disabled in the UE, determining first validity information associated with the SNPN,, and re-enabling the N1 mode capability upon determining that the status of the first validity information associated with the SNPN changes from not met to met.

In accordance with another aspect of the disclosure, a system for re-enabling a N1 mode capability for 3rd generation partnership project (3GPP) access in a user equipment (UE) is provided. The system includes memory, comprising one or more storage media, storing instructions and at least one processor communicatively coupled to the memory, wherein the instructions, when executed by the at least one processor individually or collectively, cause the system to determine that the UE supports access to a standalone non-public network (SNPN), identify that the N1 mode capability is disabled in the UE, determine first validity information associated with the SNPN, and re-enable the N1 mode capability upon determining that the first validity information associated with the SNPN changes from not met to met.

In accordance with another aspect of the disclosure, one or more non-transitory computer-readable storage media storing one or more computer programs including computer-executable instructions that, when executed by one or more processors of a user equipment individually or collectively, cause the UE to perform operations are provided. The operations include determining that the UE supports an access to a standalone non-public network (SNPN), identifying that an N1 mode capability is disabled in the UE, determining a first validity information associated with the SNPN, determining and re-enabling the N1 mode capability upon determining that the first validity information associated with the SNPN changes from not met to met.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, and in which:

FIG. 1 illustrates a signal flow diagram depicting an inability of a user equipment (UE) to access standalone non-public network (SNPN) for localized services in SNPN due to N1 mode disablement for 3GPP access, according to the related art;

FIG. 2 illustrates a signal flow diagram depicting an inability of the UE to access SNPN for localized services in SNPN due to N1 mode disablement for 3GPP access, according to the related art;

FIG. 3 illustrates a flow diagram depicting a method for re-enabling an N1 mode for 3GPP access in the UE configured to support SNPNs for accessing localized services in SNPN, according to an embodiment of the disclosure;

FIGS. 4 and 5 illustrate signal flow diagrams depicting re-enabling of the NI mode for 3GPP access in the UE configured to support SNPNs for accessing localized services in SNPN, according to various embodiments of the disclosure; and

FIG. 6 illustrates a diagram of a system for re-enabling the N1 mode for 3GPP access in the UE configured to support SNPNs for accessing localized services in SNPN, according to an embodiment of the disclosure.

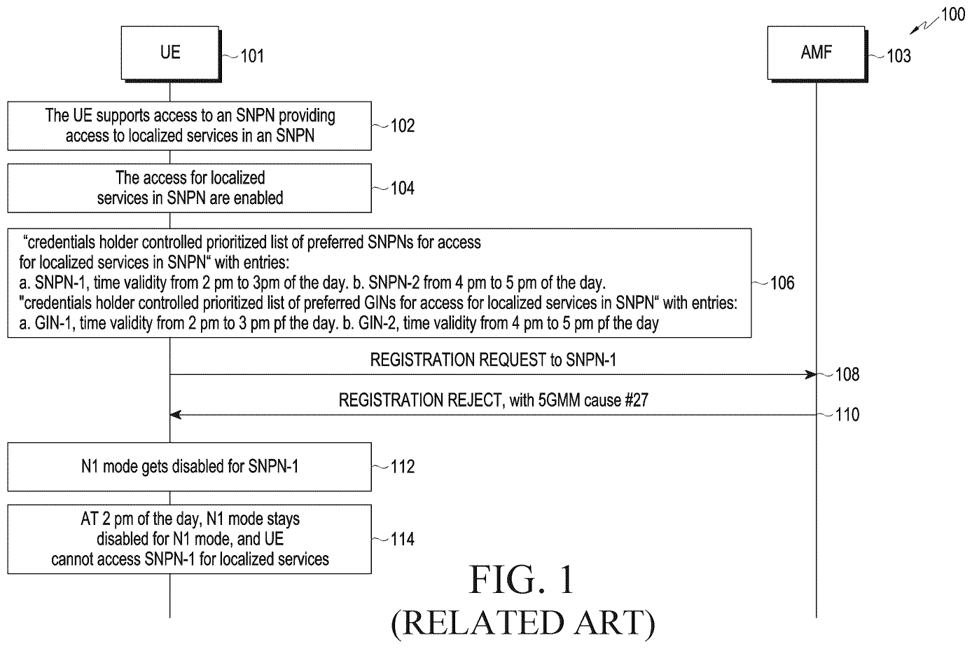

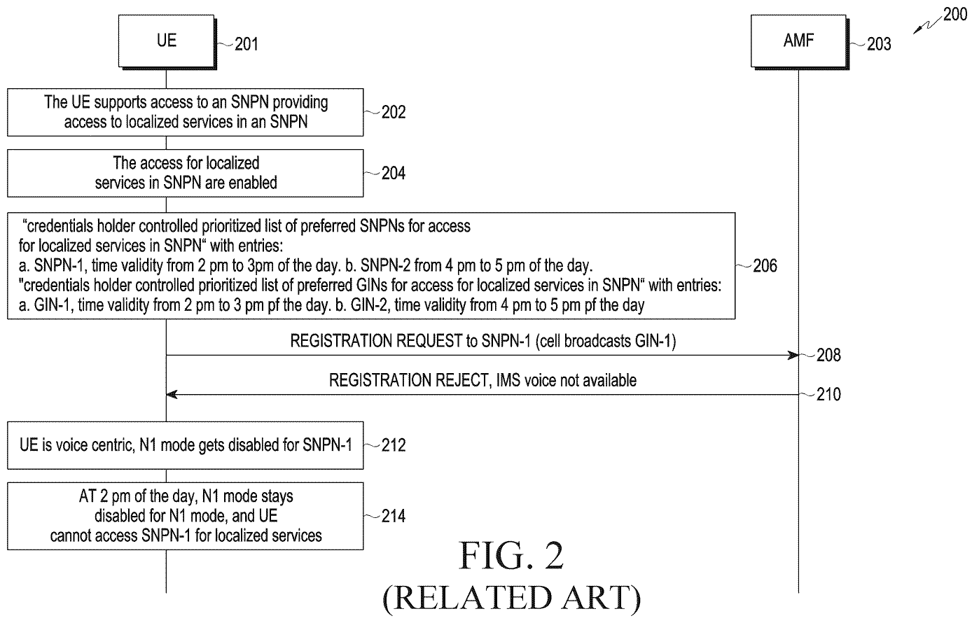

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

The disclosure discloses techniques for re-enabling the N1 mode capability for 3GPP access when the UE that supports access to an SNPN providing access for localized services in SNPN and access for localized services in SNPN is enabled.

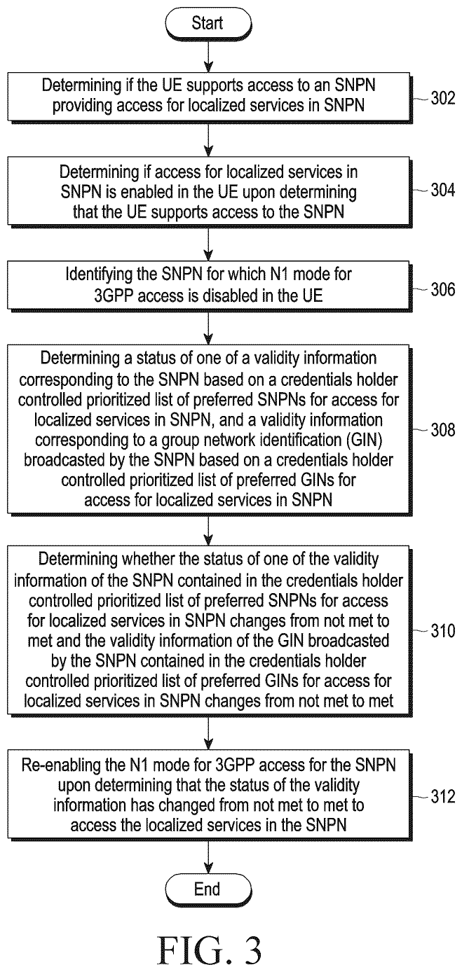

The disclosed techniques are further explained in detail with respect to FIGS. 3 to 6.

FIG. 3 illustrates a flow diagram depicting a method for re-enabling an N1 mode for 3GPP access in the UE configured to support SNPNs for accessing localized services in SNPN, according to an embodiment of the disclosure.

Referring to FIG. 3, at operation 302, the method may include determining if the UE supports access to an SNPN providing access for localized services in SNPN. If it is determined that the UE supports access to the SNPN, at operation 304, the method may include determining if access for localized services in SNPN is enabled in the UE. Thereafter, at operation 306, the method may include identifying the SNPN for which N1 mode for 3GPP access is disabled in the UE. It should be noted that the operations 302-306 may be performed by the UE in accordance with techniques known to a person skilled in the art. In an embodiment, the UE may transmit a registration request to the SNPN through a network entity, such as AMF. In response, the UE may receive a rejection and a corresponding cause indication. In an example, the cause indication may be a 5G mobility management (5GMM) cause value #27 indicating N1 mode is not allowed. In another example, the cause indication may be 5GMM cause value #62 indicating that no network slices are available. The UE may receive the rejection and cause indication in a NAS message. The UE may disable the N1 mode for the SNPN based on the rejection and the corresponding cause indication. In an embodiment, the UE may disable the N1 mode for the SNPN due to one of the following reasons:
When IMS voice is not available over packet switched (PS) data network for the SNPN, and UE is “voice centric”
When UE disables N1 mode due to the registration attempt counter reaching the maximum value.

It should be noted that the examples stated above are not the only limited examples leading to N1 mode getting disabled for the SNPN. The UE may disable the SNPN due to any other reason and any such reason falls within the scope of the disclosure.

Referring to FIG. 3, at operation 308, the method may include determining a status of one of a validity information corresponding to the SNPN based on a credentials holder controlled prioritized list of preferred SNPNs for access for localized services in SNPN and a validity information corresponding to a group network identification (GIN) broadcasted by the SNPN based on a credentials holder controlled prioritized list of preferred GINs for access for localized services in SNPN. In an embodiment, the credentials holder controlled prioritized list of preferred SNPNs for access for the localized services in SNPN may include but is not limited to at least an identification information of each of the preferred SNPNs, and corresponding validity information for access for the localized services in the SNPN. In particular, there could be more than one SNPNs, i.e., preferred SNPNs in the vicinity of the UE. Accordingly, the credentials holder controlled prioritized list of preferred SNPNs for access for the localized services in SNPN may include the identification information of each of these SNPNs and corresponding validity information. The validity information may indicate at least one of a time validity information, a location validity information, and a location assistance information corresponding to the SNPN. The time validity information may indicate a time period during which the localized services are available from the corresponding SNPN. For example, the localized services may be available from 2 pm-5 pm of the day. The location validity information consists of specific areas i.e. Tracking Area(s) of an SNPN where access for localized services in the SNPN is available. The location assistance information consists of Geolocation information, and/or tracking area information of serving networks, i.e. lists of tracking area codes (TACs) per PLMN ID or per PLMN ID and network identification (NID).

In a further embodiment, the credentials holder controlled prioritized list of preferred GINs for access for localized services in SNPN may include but is not limited to identification of each of the GINs and corresponding validity information for access for the localized services in the SNPN. The validity information is same as discussed in reference to the credentials holder controlled prioritized list of preferred SNPNs for access for the localized services in SNPN.

In an embodiment, the UE may receive at least one of the credentials holder controlled prioritized list of preferred SNPNs for access for localized services in SNPN and the credentials holder controlled prioritized list of preferred group network identifications (GINs) for access for localized services in SNPN as a part of a steering of roaming SNPN selection information for localized services in SNPN (SOR-SNPN-SI-LS) from the network entity, such as AMF.

Referring to FIG. 3, at operation 310, the method may include determining whether the status of one of the validity information associated with the SNPN and the GIN changes from not met to met to access the localized services in the SNPN. In an embodiment, the UE may determine if the status of one of the validity information associated with the SNPN and the GIN changes from not met to met based on at least one of a current time of the UE and a location of the UE. In an embodiment, the status of the time validity information is changed from not met to met. For example, the time validity information indicates that localized services at the SNPN are available from 2 pm-5 pm of the day. The current time instance indicates that the current time is 5 pm. Accordingly, the UE may determine that the status of the validity information changes from not met to met to access the localized services in the SNPN. Further, if the location validity information is not available and at least one time period of the time validity information matches UE's current time, or the location validity information is available, at least one time period of the time validity information matches UE's current time and at least one location information of the location validity information matches UE's current location, the validity information is met otherwise the validity information is not met.

Then, at operation 312, the method may include re-enabling the N1 mode for 3GPP access for the SNPN upon determining that the status of one of the validity information associated with the SNPN and the GIN changes from not met to met to access the localized services in the SNPN. In an embodiment, the UE may re-enable the N1 mode for 3GPP access for a time period for providing the localized services indicated by the validity information, such as between 2 pm-5 pm. In an embodiment, the UE may re-enable the N1 mode for 3GPP access in a periodic manner, such as every day between 2 pm-5 pm. In an embodiment, the UE may re-enable the N1 mode for 3GPP access for a specified time period. The specified time period may be configured by the network entity.

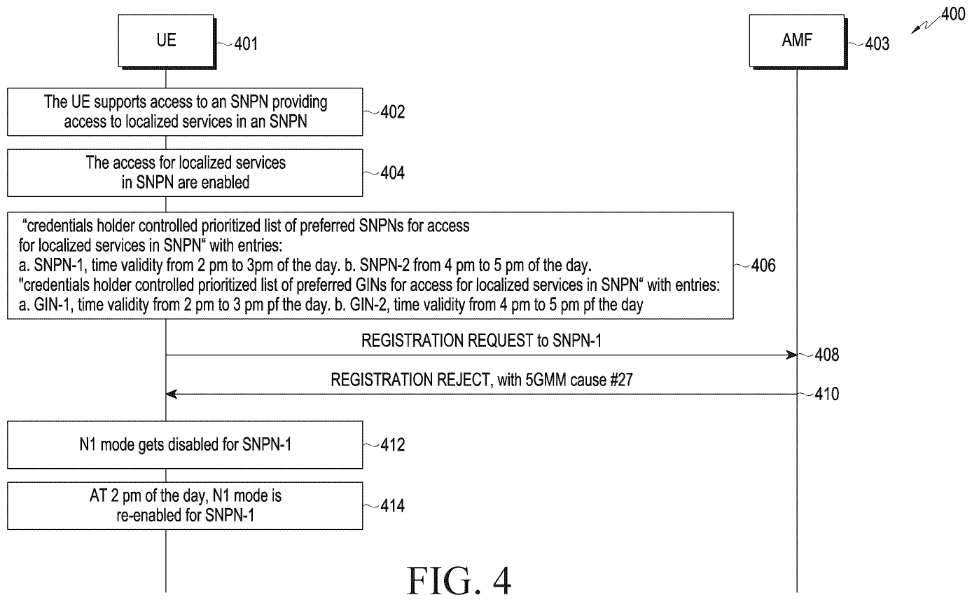

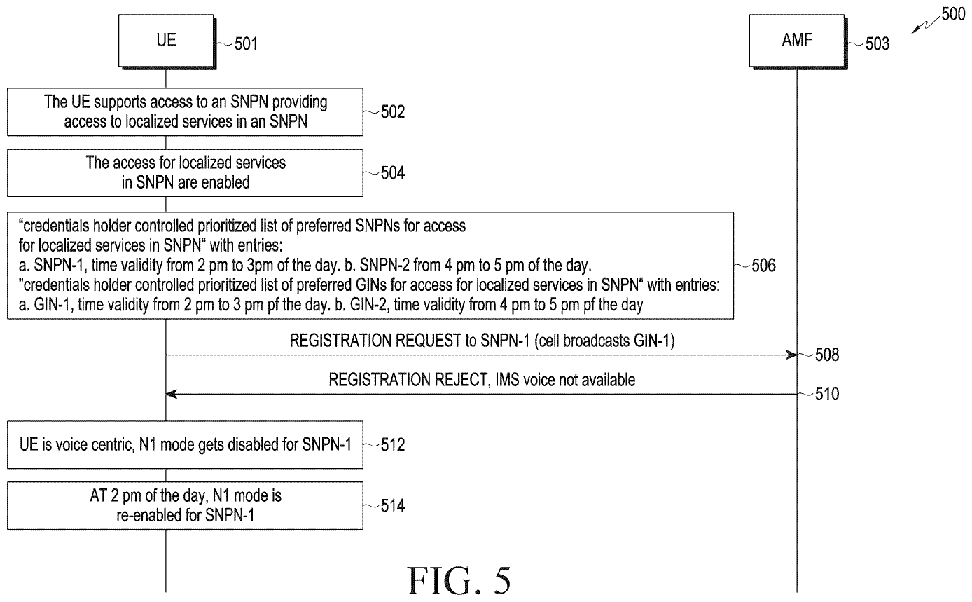

FIGS. 4 and 5 illustrate signal flow diagrams 400 and 500 respectively, depicting re-enabling of the NI mode for 3GPP access in the UE configured to support SNPNs for accessing localized services in SNPN, according to various embodiments of the disclosure.

Referring to FIG. 4, at operation 402, the UE 401 supports access to the SNPN providing access to localized services in the SNPN. At operation 404, the access for localized services in SNPN may be enabled. At operation 406, the UE 401 may be configured with the below, for the selected entry of the “list of subscriber data” or PLMN subscription:
i) “credentials holder controlled prioritized list of preferred SNPNs for access for localized services in SNPN” with entries, for example:
a. SNPN-1, time validity from 2 pm to 3 pm of the day.
b. SNPN-2 from 4 pm to 5 pm of the day.
ii) “credentials holder controlled prioritized list of preferred GINs for access for localized services in SNPN” with entries, for example:
a. GIN-1, time validity from 2 pm to 3 pm of the day.
b. GIN-2, time validity from 4 pm to 5 pm of the day.

At operation 408, the UE 401 tries to access SNPN-1. For example, the UE401 tries to register with SNPN-1 by transmitting a registration request to the AMF 403. At operation 410, the Event-X is triggered. For example, the UE 401 receives the NAS message from the AMF 403 i.e., registration rejection with cause #27 (N1 mode not allowed). At operation 412, the event-X triggers the N1 mode to get disabled for SNPN-1, for instance at 1 pm of the day. At operation 414, at 2 pm of the day, the N1 mode is re-enabled for SNPN-1, and the UE 401 may access SNPN-1 for the localized services. Hence, the N1 mode is re-enabled when the status of the time validity information is changed.

Referring to FIG. 5, at operation 502, the UE 501 supports access to the SNPN providing access to localized services in the SNPN. At operation 504, the access for localized services in the SNPN may be enabled. At operation 506, the UE 501 is configured with the below, for the selected entry of the “list of subscriber data” or PLMN subscription:
i) “credentials holder controlled prioritized list of preferred SNPNs for access for localized services in SNPN” with entries for example:
a. SNPN-1, time validity from 2 pm to 3 m of the day.
b. SNPN-2 from 4 pm to 5 pm of the day.
ii) “credentials holder controlled prioritized list of preferred GINs for access for localized services in SNPN” with entries:
a. GIN-1, time validity from 2 pm to 3 pm of the day.
b. GIN-2, time validity from 4 pm to 5 pm of the day.

At operation 508, the UE 501 tries to access SNPN-1. In an example, the UE 501 tries to register with SNPN-1 using GIN-1, i.e., GIN associated with SNPN-1. The UE 501 may receive GIN-1 from a network associated with the AMF 503. Accordingly, the UE 501 may try to register with the SNPN-1 by transmitting GIN-1 to the AMF 503. At operation 510, the Event-X is triggered. For example, the UE 501 receives the NAS message, i.e., example registration accept, with IMS voice not available, and the UE's usage setting is “Voice centric”. At operation 512, the event-X triggers the NI mode to get disabled for SNPN-1, for example at 1 pm of the day. At operation 514, at 2 pm of the day, N1 mode is re-enabled for SNPN-1, and the UE 501 may access SNPN-1 for localized services. Hence, the N1 mode is re-enabled when the time validity information is changed.

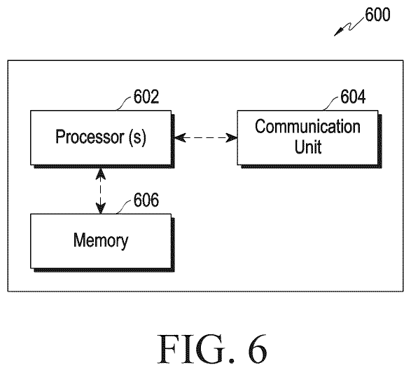

FIG. 6 illustrates a diagram of a system for re-enabling the N1 mode for 3GPP access in the UE configured to support SNPNs for accessing localized services in SNPN, according to an embodiment of the disclosure.

The configuration of FIG. 3 may be understood as a part of the configuration of the UE. Further, the method as disclosed above may be implemented in the system 600 according to a further embodiment. Non-limiting examples of the system 600 are an electronic device, a mobile device, a user equipment, a base station, or a radio station.

In an embodiment, the system 600 corresponds to the UE. Referring to FIG. 6, the system 600 may include “processor(s)” which is at least one processor 602, a communication circuit 604 (e.g., communicator or communication interface), and memory 606.

As an example, the at least one processor 602 may be a single processor or a number of processors, all of which could include multiple computing circuits. The processor 602 may be implemented as one or more microprocessors, microcomputers, microcontrollers, digital signal processors, central processing units, state machines, logic circuitries, and/or any devices that manipulate signals based on operational instructions. Among other capabilities, the processor 602 is configured to fetch and execute computer-readable instructions and data stored in the memory 606. The processor 602 may include one or a plurality of processors. At this time, one or a plurality of processors 602 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 602 may control the processing of the input data in accordance with a specified operating rule or artificial intelligence (AI) model stored in the non-volatile memory and the volatile memory, i.e., the memory 606. The specified operating rule or AI model is provided through training or learning.

The memory 606 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 606 may also store the credentials holder controlled prioritized list of preferred SNPNs for access for localized services in SNPN and the credentials holder controlled prioritized list of preferred GINs for access for localized services in SNPN, in accordance with techniques disclosed in the disclosure.

The system 600 may include additional components required to implement the desired functionality of the system 600 in accordance with the requirements of the disclosure.

Accordingly, the disclosure provides various advantages. For example, the disclosure provides techniques to re-enable N1 mode for 3GPP services access in the UE configured to support SNPNs for accessing localized services in SNPN.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disc (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

The foregoing description of the various embodiments will so fully reveal the general nature of the embodiments herein that others can, by applying current knowledge, readily modify and/or adapt for various applications such various embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for re-enabling an N1 mode capability for 3rd generation partnership project (3GPP) access in a user equipment (UE), the method comprising:
determining that the UE supports an access to a standalone non-public network (SNPN);
identifying that the N1 mode capability is disabled in the UE;
determining first validity information associated with the SNPN; and
re-enabling the N1 mode capability upon determining that the first validity information associated with the SNPN changes from not met to met.

2. The method of claim 1, further comprising:
determining that an access for localized services in the SNPN is enabled in the UE upon determining that the UE supports the access to the SNPN.

3. The method of claim 2, wherein the first validity information is based on a credentials holder controlled prioritized list of preferred SNPNs for the access for localized services in the SNPN.

4. The method of claim 1, further comprising:
determining second validity information associated with a group network identification (GIN) broadcasted by the SNPN; and
re-enabling the N1 mode capability upon determining that the second validity information changes from not met to met.

5. The method of claim 1, further comprising:
determining whether the N1 mode capability is disabled due to a fifth generation (5G) mobility management (5GMM) cause indicating the N1 mode capability being not allowed; and
keeping the N1 mode capability as disabled.

6. The method of claim 3, wherein the credentials holder controlled prioritized list of preferred SNPNs for the access for the localized services in the SNPN includes at least an identification information of each of the preferred SNPNs, and corresponding validity information for the access for the localized services in the SNPN.

7. The method of claim 4,
wherein the second validity information is based on a credentials holder controlled prioritized list of preferred GINs for access for localized services in the SNPN,
wherein the credentials holder controlled prioritized list of preferred GINs for the access for the localized services in the SNPN provide an identification of each of the GINs, and corresponding validity information for the access for the localized services in the SNPN.

8. The method of claim 1, wherein the first validity information consists at least one of a time validity information, a location validity information, and a location assistance information corresponding to the SNPN.

9. The method of claim 4, wherein the second validity information consists at least one of a time validity information, a location validity information, and a location assistance information corresponding to the GIN.

10. The method of claim 3, further comprising:
receiving, from a network entity, the credentials holder controlled prioritized list of preferred SNPNs for the access for the localized services in the SNPN as a part of a steering of roaming SNPN selection information for the localized services in the SNPN (SOR-SNPN-SI-LS).

11. The method of claim 2, wherein re-enabling the N1 mode capability comprises at least one of:
re-enabling the N1 mode capability for a time period for providing the localized services indicated by the first validity information;
re-enabling the N1 mode capability in a periodic manner; and
re-enabling the N1 mode capability for a specified time period.

12. The method of claim 1, wherein prior to identifying the N1 mode capability, the method comprises:
transmitting a registration request to the SNPN through a network entity;
receiving a rejection and a corresponding cause indication; and
disabling the N1 mode capability based on the rejection and the corresponding cause indication.

13. A system for re-enabling an N1 mode capability for 3rd generation partnership project (3GPP) access in a user equipment (UE), the system comprising:
memory, comprising one or more storage media, storing instructions; and
at least one processor communicatively coupled to the memory, wherein the instructions, when executed by the at least one processor individually or collectively, cause the system to:
determine that the UE supports access to a standalone non-public network (SNPN),
identify that the N1 mode capability is disabled in the UE,
determine first validity information associated with the SNPN, and
re-enable the N1 mode capability upon determining that the first validity information associated with the SNPN changes from not met to met.

14. The system of claim 13, wherein the instructions, when executed by the at least one processor individually or collectively, further cause the system to:
determine that an access for localized services in the SNPN is enabled in the UE upon determining that the UE supports the access to the SNPN.

15. The system of claim 14, wherein the first validity information is based on a credentials holder controlled prioritized list of preferred SNPNs for the access for localized services in the SNPN.

16. The system of claim 13, wherein the instructions, when executed by the at least one processor individually or collectively, further cause the system to:
determine second validity information associated with a group network identification (GIN) broadcasted by the SNPN; and
re-enable the N1 mode capability upon determining that the second validity information changes from not met to met.

17. The system of claim 13, wherein N1 mode capability was disabled in the UE due to one of: a registration attempt counter reaching a maximum value, the UE receiving a rejection indicating that no network slices are available, the UE receiving a rejection indicating that N1 mode capability is not allowed, or IP multimedia subsystem (IMS) voice is not available over a packet switched (PS) data network for the SNPN and a usage setting of the UE is voice centric.

18. The system of claim 14, wherein the first validity information includes at least one of:
time validity information indicating a time period during which the localized services are available from a corresponding SNPN,
location validity information including specific areas of an SNPN where access for localized services in the SNPN is available, or location assistance information including geolocation information, and/or tracking area information of serving networks.

19. One or more non-transitory computer-readable storage media storing one or more computer programs including computer-executable instructions that, when executed by one or more processors of a user equipment (UE) individually or collectively, cause the UE to perform operations, the operations comprising:
determining that the UE supports an access to a standalone non-public network (SNPN);
identifying that an N1 mode capability is disabled in the UE;
determining first validity information associated with the SNPN; and
re-enabling the N1 mode capability upon determining that the first validity information associated with the SNPN changes from not met to met.

20. The one or more non-transitory computer-readable storage media of claim 19, the operations further comprising:
determining that an access for localized services in the SNPN is enabled in the UE upon determining that the UE supports the access to the SNPN.
